(19) United States
(12) Patent Application Publication
(10) Pub. No.: US 2025/0092181 A1
(43) Pub. Date: Mar. 20, 2025

(54) PREPOLYMER COMPOSITION, POLYURETHANE RESIN, ELASTIC MOLDED ARTICLE, AND METHOD OF PRODUCING PREPOLYMER COMPOSITION

(71) Applicant: MITSUI CHEMICALS, INC., Tokyo (JP)

(72) Inventor: Kazuhiro MAEKAWA, Sodegaura-shi, CHIBA (JP)

(21) Appl. No.: 18/724,073

(22) PCT Filed: Feb. 7, 2023
(86) PCT No.: PCT/JP2023/003985

§ 371 Date: Jun. 25, 2024

(30) Foreign Application Priority Data
Feb. 9, 2022 (JP) 2022-018383

(51) Int. Cl. C08G 18/10; C08G 18/32; C08G 18/75

(52) U.S. Cl. CPC C08G 18/10; C08G 18/3206; C08G 18/757

(57) ABSTRACT

A prepolymer composition containing an isocyanate group-terminated prepolymer is provided. The isocyanate group-terminated prepolymer contains a reaction product of a polyisocyanate component including 1,4-bis(isocyanatomethyl)cyclohexane and a polyol component. The isocyanate group-terminated prepolymer has a dispersion index (Mw/Mn) of 1.85 or less. The prepolymer composition has an isocyanate group concentration of 14.0% by mass or less.

### TECHNICAL FIELD

The present invention relates to a prepolymer composition, a polyurethane resin, an elastic molded article, and a method of producing the prepolymer composition.

### BACKGROUND ART

A polyurethane resin has, for example, a soft segment formed by the reaction of a polyisocyanate with a macropolyol and a hard segment formed by the reaction of a polyisocyanate with a chain extender.

More specifically, a polyurethane resin produced by the following method has been known. That is to say, first, 1118 parts by mass of 1,4-bis(isocyanatomethyl)cyclohexane is reacted with 2881 parts by mass of a polytetramethylene ether glycol having a number average molecular weight of 1000 to produce an isocyanate group-terminated prepolymer. Next, each of 150 parts by mass of the isocyanate group-terminated prepolymer and 7.62 to 8.71 parts by mass of a 1,4-butylene glycol is preliminarily heated to 80° C. and then mixed together. At that time, the equivalent ratio (NCO/active hydrogen group) is 1.12 to 1.28. Furthermore, 0.0008 parts by mass of dibutyltin dilaurate is added to the mixture, and the mixture was poured into a mold and cured at 110° C. for 24 hours to produce a polyurethane elastomer (for example, see Patent Document 1 (Synthesis Example 1 and Examples 1 to 5)).

### CITATION LIST

### Patent Document

Patent Document 1: Japanese Unexamined Patent Publication No. 2014-231585

### SUMMARY OF THE INVENTION

### Problem to be Solved by the Invention

The above-described polyurethane elastomer has excellent mechanical properties. However, the above-described polyurethane elastomer may have a high exothermic property. Furthermore, further improvement of the mechanical properties of the polyurethane elastomer has been required.

The present invention includes a prepolymer composition for producing a polyurethane resin having excellent mechanical properties (high hardness) and a low exothermic property, a polyurethane resin and an elastic molded article that are produced from the prepolymer composition, and a method of producing the prepolymer composition.

### Means for Solving the Problem

The present invention [1] includes a prepolymer composition including: an isocyanate group-terminated prepolymer, wherein the isocyanate group-terminated prepolymer contains a reaction product of a polyisocyanate component including 1,4-bis(isocyanatomethyl)cyclohexane and a polyol component, wherein the isocyanate group-terminated prepolymer has a dispersion index (Mw/Mn) of 1.85 or less, and wherein the prepolymer composition has an isocyanate group concentration of 14.0% by mass or less.

The present invention [2] includes a polyurethane resin including: a reaction product of a prepolymer composition including an isocyanate group-terminated prepolymer and a chain extending component, wherein the isocyanate group-terniinated prepolymer contains a reaction product of a polyisocyanate component including 1,4-bis(isocyanatonethyl)cyclohexane and a polyol component, wherein the isocyanate group-terminated prepolymer has a dispersion index (Mw/Mn) of 1.85 or less, and wherein the prepolymer composition has an isocyanate group concentration of 14.0% by mass or less.

The present invention [3] includes an elastic molded article including: the polyurethane resin described in the above-described [2].

The present invention [4] includes a method of producing a prepolymer composition containing an isocyanate group-terminated prepolymer, the method including: a first step of allowing a polyisocyanate component including 1,4-bis(isocyanatomethyl)cyclohexane to react with a polyol component to prepare a reaction mixture including an isocyanate group-terminated prepolymer; and a second step of distilling the reaction mixture, wherein in the first step, an equivalent ratio (NCO/OH) of an isocyanate group in the polyisocyanate component to a hydroxyl group in the polyol component is 7.0 or more, wherein the isocyanate group-terminated prepolymer has a dispersion index (Mw/Mn) of 1.85 or less, and wherein the prepolymer composition has an isocyanate group concentration of 14.0% by mass or less.

The present invention [5] includes a method of producing a prepolymer composition described in the above-described [4], the method including: a third step of adding an isocyanate monomer to a purified solution produced by the distillation after the second step, wherein the isocyanate monomer contains 1,4-bis(isocyanatomethyl)cyclohexane.

### Effects of the Invention

In the present invention, the prepolymer composition has an isocyanate group concentration less than a predetermined value. Furthermore, in the present invention, the isocyanate group-terminated prepolymer contained in the prepolymer composition has a dispersion index (Mw/Mn) less than a predetermined value.

Therefore, according to the prepolymer composition of the present invention, a polyurethane resin having both excellent mechanical properties (high hardness) and a low exothermic property can be produced.

The polyurethane resin and elastic molded article of the present invention have both excellent mechanical properties (high hardness) and a low exothermic property.

According to the method of producing the prepolymer composition of the present invention, the above-described prepolymer composition can be produced.

### DESCRIPTION OF THE EMBODIMENTS

A polyurethane resin contains a reaction product of a prepolymer composition (a first solution) and a chain extending component (a second solution). The prepolymer composition (the first solution) and the chain extending component (the second solution) are, for example, prepared as a resin kit and are mixed together to cause a urethane-forming reaction.

The polyurethane resin preferably consists of a reaction product of the prepolymer composition (the first solution) and the chain extending component (the second solution). That is to say, the polyurethane resin is preferably a cured urethane product produced by the reaction of the prepolymer composition with the chain extending component, and the curing of them.

The prepolymer composition (the first solution) contains an isocyanate group-terminated prepolymer as an essential component.

The isocyanate group-terminated prepolymer includes a reaction product of a polyisocyanate component and a polyol component. Preferably, the isocyanate group-terminated prepolymer consists of a reaction product of a polyisocyanate component and a polyol component.

The polyisocyanate component includes 1,4-bis(isocyanatomethyl)cyclohexane as an essential component. The 1,4-bis(isocyanatomethyl)cyclohexane has a cis-1,4-bis(isocyanatomethyl)cyclohexane and a trans-1,4-bis(isocyanatomethyl)cyclohexane as a stereoisomer. Hereinafter, the cis-1,4-bis(isocyanatomethyl)cyclohexane may be referred to as a cis-1,4 isomer. Furthermore, the trans-1,4-bis(isocyanatomethyl)cyclohexane may be referred to as a trans-1,4 isomer. The total amount of the trans-1,4 isomer and the cis-1,4 isomer is100 mol %.

In the 1,4-bis(isocyanatomethyl)cyclohexane, the content ratio of the trans-1,4 isomer is, for example, 60 mol % or more, preferably 70 mol % or more, more preferably 80 mol % or more, even more preferably 85 mol % or more. Furthermore, in the 1,4-bis(isocyanatomethyl)cyclohexane, the content ratio of the trans-1,4 isomer is, for example, 100 mol % or less, preferably 99.8 mol % or less, more preferably 99 mol % or less, even more preferably 96 mol % or less, even more preferably 90 mol % or less.

Furthermore, in the 1,4-bis(isocyanatomethyl)cyclohexane, the content ratio of the cis-1,4 isomer is, for example, 0 mol % or more, preferably 0.2 mol % or more, more preferably 1 mol % or more, even more preferably 4 mol % or more, even more preferably 10 mol % or more. Furthermore, in the 1,4-bis(isocyanatomethyl)cyclohexane, the content ratio of the cis-1,4 isomer is, for example, 40 mol % or less, preferably 30 mol % or less, more preferably 20 mol % or less, even more preferably 15 mol % or less.

The content ratio of the trans-1,4 isomer and the content ratio of the cis-1,4 isomer are in the above-described ranges, a polyurethane resin having excellent mechanical strength can be produced.

Furthermore, the 1,4-bis(isocyanatomethyl)cyclohexane may be a modified product in a range that does not reduce the excellent effects of the present invention. Examples of the modified product include a uretdione modified product, an isocyanurate modified product, iminooxadiazinedione, a biuret modified product, an allophanate modified product, a polyol adduct, an oxadiazinetrione modified product, and a carbodiimide modified product.

The polyisocyanate component can include an isocyanate (hereinafter, another polyisocyanate) except for 1,4-bis(isocyanatomethyl)cyclohexane as an optional component in a range that does not reduce the excellent effects of the present invention. Examples of the other polyisocyanate include diisocyanate.

More specifically, examples of the other polyisocyanate include aliphatic polyisocyanate, alicyclic polyisocyanate (except for 1,4-bis(isocyanatomethyl)cyclohexane), aromatic polyisocyanate, and araliphatic polyisocyanate. Examples of the aliphatic polyisocyanate include trimethylene diisocyanate, tetramethylene diisocyanate, pentamethylene diisocyanate (PDI), hexamethylene diisocyanate (HDI), 1,2-propane diisocyanate, 1,2-butane diisocyanate, 2,3-butane diisocyanate, 1,3-butane diisocyanate, 2,4,4-trimethyl hexamethylene diisocyanate, 2,2,4-trimethyl hexamethylene diisocyanate, and 2,6-diisocyanate methylcaproate. Examples of the alicyclic polyisocyanate include 1,3-bis(isocyanatomethyl) cyclohexane (1,3-H₆XDI), isophorone diisocyanate (IPDI), norbornene diisocyanate (NBDI), and methylene bis(cyclohexyl isocyanate) (H₁₂VMI). Examples of the aromatic polyisocyanate include tolylene diisocyanate (TDI), diphenylmethane diisocyanate (MDI), toluidine diisocyanate (TODI), paraphenylene diisocyanate, and naphthalene diisocyanate (NDI). Examples of the araliphatic polyisocyanate include xylylene diisocyanate (XDI) and tetramethyl xylylene diisocyanate (TMXDI). Alternatively, the other polyisocyanate may be the above-described modified product in a range that does not reduce the excellent effects of the present invention. These can be used alone or in combination of two or more.

The content ratio of the other polyisocyanate to the total amount of the polyisocyanate component is, for example, 50% by mass or less, preferably 30% by mass or less, more preferably 10% by mass or less, particularly preferably 0% by mass. Furthermore, the content ratio of 1,4-bis(isocyanatomethyl)cyclohexane to the total amount of the polyisocyanate component is, for example, 50% by mass or more, preferably 70% by mass or more, more preferably 90% by mass or more, particularly preferably 100% by mass. That is to say, the polyisocyanate component particularly preferably consists of 1,4-bis(isocyanatomethyl)cyclohexane.

The polyol component contains, for example, a macropolyol. The macropolyol has two or more hydroxyl groups in its molecule, and is an organic compound having a relatively high molecular weight. A relatively high molecular weight indicates that the number average molecular weight exceeds 400.

Examples of the macropolyol include a polyether polyol, a polyester polyol, a polycarbonate polyol, a polyurethane polyol, an epoxy polyol, a vegetable oil polyol, a polyolefin polyol, an acrylic polyol, and a vinyl monomer-modified polyol. As the macropolyol, preferably, a polyether polyol, a polyester polyol, and a polycarbonate polyol are used.

Examples of the polyether polyol includes a polyoxyalkylene polyol. Examples of the polyoxyalkylene polyol include a polyoxyalkylene (C2-3) polyol, and a polytetramethylene ether polyol.

Examples of the polyester polyol include a condensed polyester polyol and a ring-opening polyester polyol. Examples of the condensed polyester polyol include an adipate-based polyester polyol (for example, polybutylene adipate) and a phthalate-based polyester polyol. Examples of the ring-opening polyester polyol include a lactone-based polyester polyol, more specifically include a polycaproctone polyol.

Examples of the polycarbonate polyol include a ring-opening polymer of ethylene carbonate using a low molecular-weight polyol described below as an initiator.

These macropolyols can be used alone or in combination of two or more. In view of the low exothermic property and mechanical properties, as the macropolyol, a polyether polyol is preferably is used, and a polytetramethylene ether polyol is more preferably used.

The macropolyol has a number average molecular weight of more than 400, preferably 500 or more, more preferably 650 or more, even more preferably 1000 or more. Furthermore, the macropolyol has a number average molecular weight of, for example, 5000 or less, preferably 3000 or less, more preferably 2000 or less, even more preferably 1500 or less. Furthermore, an average functionality (the average number of hydroxyl groups) of the macropolyol is, for example, 2 or more. Furthermore, the average functionality (the average number of hydroxyl groups) of the macropolyol is, for example, 6 or less, preferably 4 or less, more preferably 3 or less, even more preferably 2.5 or less.

The macropolyol has a hydroxyl group value of, for example, 50 mgKOH/g or more, preferably 100 mgKOH/g or more. Furthermore, the macropolyol has a hydroxyl group value of, for example, 400 mgKOH/g or less, preferably 300 mgKOH/g or less, more preferably 180 mgKOH/g or less, even more preferably 150 mgKOH/g or less. The hydroxyl group value can be measured, for example, by a known method of measuring a hydroxyl group value. Examples of the method of measuring a hydroxyl group value include an acetylation method and a phthalated method. Furthermore, the hydroxyl group value can also be calculated from the material ratio of the macropolyol.

The polyol component can include a low molecular-weight polyol.

The low molecular-weight polyol has two or more hydroxyl groups in its molecule, and is an organic compound having a relatively low molecular weight. A relatively low molecular weight indicates that the number average molecular weight is 400 or less. That is to say, a low molecular-weight polyol has a molecular weight of, for example, 400 or less, preferably 300 or less.

Furthermore, a low molecular-weight polyol normally has a molecular weight of 40 or more.

Examples of the low molecular-weight polyol include a dihydric alcohol, a trihydric alcohol, and a tetrahydric or more alcohol. Examples of the dihydric alcohol include an ethylene glycol, a 1,2-propanediol, a 1,3-propanediol, a 1,2-butanediol, a 1,3-butanediol, a 1,4-butanediol, a 1,5-pentanediol, a 1,6-hexanediol, a neopentyl glycol, a diethylene glycol, a triethylene glycol, and a dipropylene glycol. Examples of the trihydric alcohol include glycerin and trimethylolpropane. Examples of the tetrahydric or more alcohol include pentaerythritol and diglycerin. Furthermore, examples of the low molecular-weight polyol also include a polymer produced by the additional polymerization of alkylene (C2˜3) oxide to a dihydric to tetrahydric alcohol so that the number average molecular weight becomes 400 or less. These can be used alone or in combination of two or more.

The content ratio of the low molecular-weight polyol to the total amount of the polyol component is, for example, 10% by mass or less, preferably 5% by mass or less, more preferably 1% by mass or less, particularly preferably 0% by mass. Furthermore, the content ratio of the macropolyol to the total amount of the polyol component is, for example, 90% by mass or more, preferably 95% by mass or more, more preferably 99% by mass or more, particularly preferably 100% by mass. That is to say, the polyol component particularly preferably consists of a macropolyol.

The method of producing the isocyanate group-terminated prepolymer is described below.

The content ratio of the isocyanate group-terminated prepolymer is appropriately set so that the isocyanate group concentration of the prepolymer composition is in a range described below.

More specifically, with respect to the total amount of the prepolymer composition, the isocyanate group-terminated prepolymer is, for example, 75% by mass or more, preferably 80% by mass or more, more preferably 85% by mass or more. Furthermore, with respect to the total amount of the prepolymer composition, the isocyanate group-terminated prepolymer is, for example, 100% by mass or less, preferably 95% by mass or less, more preferably 90% by mass or less.

The isocyanate group-terminated prepolymer has an isocyanate group concentration of, for example, 3.0% by mass or more, preferably 5.0% by mass or more. Furthermore, the isocyanate group-terminated prepolymer has an isocyanate group concentration of, for example, 20.0% by mass or less, preferably 15.0% by mass or less, more preferably 10.0% by mass or less. The isocyanate group concentration can be obtained by a known measurement method. Examples of the measurement method include titrimetry using di-n-butylamine and FT-IR analysis (hereinafter the same applies).

The isocyanate group-terminated prepolymer has a weight-average molecular weight (Mw) of, for example, 1500 or more, preferably 2000 or more, more preferably 2500 or more, even more preferably 3000 or more. Furthermore, the isocyanate group-terminated prepolymer has a weight-average molecular weight of, for example, 5000 or less, preferably 4000 or less, more preferably 3500 or less.

The weight-average molecular weight can be measured by a known gel permeation chromatography (GPC) (hereinafter the same applies). The details of the conditions for the GPC measurement are described below as Examples.

Furthermore, the number average molecular weight (Mn) of the isocyanate group-terminated prepolymer is normally smaller than the weight-average molecular weight (Mw) of the isocyanate group-terminated prepolymer. More specifically, the isocyanate group-terminated prepolymer has a number average molecular weight (Mn) of, for example, 500 or more, preferably 1000 or more, more preferably 1500 or more, even more preferably 2000 or more. Furthermore, the isocyanate group-terminated prepolymer has a number average molecular weight of, for example, 3000 or less, preferably 2500 or less, more preferably 2000 or less. The number average molecular weight can be measured by a known gel permeation chromatography (GPC) (hereinafter the same applies). The details of the conditions for the GPC measurement are described below as Examples.

The weight-average molecular weight and number average molecular weight of the isocyanate group-terminated prepolymer are calculated, for example, by the GPC measurement of the purified solution (described below) of the isocyanate group-terminated prepolymer.

Furthermore, the weight-average molecular weight and number average molecular weight of the isocyanate group-terminated prepolymer can also be measured as the weight-average molecular weight and number average molecular weight of the part obtained by removing the isocyanate monomer from the prepolymer composition described below. That is to say, in a GPC chart, the peak derived from the isocyanate group-terminated prepolymer is separated from the peak derived from the isocyanate monomer, and the weight-average molecular weight and number average molecular weight of the isocyanate group-terminated prepolymer can be calculated based on the peak derived from the isocyanate group-terminated prepolymer.

Then, the isocyanate group-terminated prepolymer has a dispersion index (Mw/Mn) of 1.85 or less, preferably 1.80 or less, more preferably 1.75 or less, even more preferably 1.70 or less, particularly preferably 1.68 or less. Furthermore, the isocyanate group-terminated prepolymer has a dispersion index (Mw/Mn) of, for example, 1.0 or more, preferably 1.2 or more, more preferably 1.4 or more.

When the dispersion index of the isocyanate group-terminated prepolymer is the above-described upper limits or less, a polyurethane resin having an excellently low exothermic property can be produced.

On the other hand, when the dispersion index of the isocyanate group-terminated prepolymer is the above-described upper limits or less, the mechanical properties of the polyurethane resin may not be sufficient, depending on the isocyanate group concentration of the isocyanate group-terminated prepolymer.

In such a case, to improve the mechanical properties of the polyurethane resin, the isocyanate group concentration of the prepolymer composition can be adjusted by adding an isocyanate monomer to the isocyanate group-terminated prepolymer.

In other words, the prepolymer composition can contain an isocyanate monomer as an optional component in addition to the isocyanate group-terminated prepolymer. Preferably, the prepolymer composition contains the isocyanate group-terminated prepolymer and an isocyanate monomer.

Examples of the isocyanate monomer include the above-described 1,4-bis(isocyanatomethyl)cyclohexane, and the other polyisocyanate (isocyanate except for 1,4-bis(isocyanatomethyl)cyclohexane) described above. These can be used alone or in combination of two or more.

As the isocyanate monomer, 1,4-bis(isocyanatomethyl)cyclohexane is preferably used. That is to say, the isocyanate monomer preferably contains 1,4-bis(isocyanatomethyl)cyclohexane, more preferably consists of 1,4-bis(isocyanatomethyl)cyclohexane. In the 1,4-bis(isocyanatomethyl)cyclohexane, the content ratios of the trans-1,4 isomer and the cis-1,4 isomer are preferably in the above-described ranges.

The isocyanate monomer is mixed with the isocyanate group-terminated prepolymer, for example, in the third step described below. In this manner, the isocyanate monomer is contained in the prepolymer composition.

The content ratio of the isocyanate monomer is appropriately set so that the isocyanate group concentration of the prepolymer composition is in a range described below.

More specifically, with respect to the total amount of the prepolymer composition, the isocyanate monomer is, for example, 0% by mass or more, preferably 5% by mass or more, more preferably 10% by mass or more. Furthermore, with respect to the total amount of the prepolymer composition, the isocyanate monomer is, for example, 25% by mass or less, preferably 20% by mass or less, more preferably 15% by mass or less.

The method of producing the prepolymer composition is described below.

In view of the mechanical properties, the prepolymer composition has an isocyanate group concentration of, for example, 5.0% by mass or more, preferably 7.0% by mass or more, more preferably 9.0% by mass or more, even more preferably 10.0% by mass or more, particularly preferably 12.0% by mass or more.

Furthermore, in view of the low exothermic property, the prepolymer composition has an isocyanate group concentration of 140.0% by mass or less, preferably 130.5% by mass or less, more preferably 130.0% by mass or less, even more preferably 120.5% by mass or less.

The prepolymer composition can contain an additive as an optional component. Examples of the additive include a urethane-forming catalyst (for example, an organometallic catalyst), a catalytic activity adjusting agent (for example, acetylacetone), an antioxidant, a heat-resistant stabilizer, a light-resistant stabilizer, an ultraviolet absorber, an antiblocking agent, a mold release agent, a pigment, a dye, a lubricant, a filler, a hydrolysis inhibitor, an antirust agent, and a bluing agent. The added amount of the additive and the timing of the addition are appropriately set depending on the purpose and use.

The chain extending component (the second solution) contains, for example, a chain extender (a chain extending compound).

The chain extender is a curing agent for the prepolymer composition. Examples of the chain extender include a low molecular-weight polyol and a low molecular weight polyamine. As the chain extender, preferably, a low molecular-weight polyol is used. By using a low molecular-weight polyol, a polyurethane resin having excellent mechanical strength can be produced.

Examples of the low molecular-weight polyol include the above-described low molecular-weight polyols. More specifically, examples of the low molecular-weight polyol include the above-described dihydric alcohols, the above-described trihydric alcohols, and the above-described tetrahydric or more alcohols. These can be used alone or in combination of two or more.

As the low molecular-weight polyol, dihydric alcohols and trihydric alcohols are preferably used, dihydric alcohols are more preferably used, 1, 4-butanediol is even more preferably used. That is to say, the low molecular-weight polyol preferably contains 1, 4-butanediol, more preferably consists of 1, 4-butanediol. In this manner, a polyurethane resin having excellent mechanical strength can be produced.

The chain extending component can contain an additive as an optional component. Examples of the additive include a urethane-forming catalyst (for example, an organometallic catalyst), a catalytic activity adjusting agent (for example, an acetylacetone), an antioxidant, a heat-resistant stabilizer, a light-resistant stabilizer, an ultraviolet absorber, an antiblocking agent, a mold release agent, a pigment, a dye, a lubricant, a filler, a hydrolysis inhibitor, an antirust agent, and a bluing agent. The added amount of the additive and the timing of the addition are appropriately set depending on the purpose and use.

The method of producing the prepolymer composition and the method of producing the polyurethane resin are detailed below.

In this method, first, an isocyanate group-terminated prepolymer is synthesized (the first step). Next, the isocyanate group-terminated prepolymer is purified (the second step). Next, an isocyanate monomer is blended thereto (the third step). Thereafter, a polyurethane resin is synthesized (the fourth step).

More specifically, in this method, first, the above-described polyisocyanate component and the above-described polyol component are reacted in a predetermined ratio to prepare a reaction mixture including the isocyanate group-terminated prepolymer (the first step).

The content ratio of the polyisocyanate component to the polyol component is adjusted so that the dispersion index (Mw/Mn) of the isocyanate group-terminated prepolymer is in the above-described range.

More specifically, in the first step, the equivalent ratio R (NCO/OH) of the isocyanate group in the polyisocyanate component to the hydroxyl group in the polyol component is 7.0 or more, preferably 7.5 or more, more preferably 8.0 or more, even more preferably 8.5 or more. Furthermore, the equivalent ratio R (NCO/OH) of the isocyanate group in the polyisocyanate component to the hydroxyl group in the polyol component is, for example, 20 or less, preferably 15 or less.

When the content ratio of the polyisocyanate component to the polyol component is in the above-described range, the dispersion index of the isocyanate group-terminated prepolymer can relatively be lowered.

In the first step, examples of the reaction method include bulk polymerization and solution polymerization. In bulk polymerization, for example, the polyisocyanate component and the polyol component are reacted under a nitrogen gas stream. The reaction temperature is, for example, 50° C. or more. Furthermore, the reaction temperature is, for example, 250° C. or less, preferably 200° C. or less. Furthermore, the reaction time is, for example, 0.5 hours or more, preferably 1 hour or more. Furthermore, the reaction time is, for example, 15 hours or less. In solution polymerization, the polyisocyanate component and the polyol component are reacted in the presence of a known organic solvent. The reaction temperature is, for example, 50° C. or more. Furthermore, the reaction temperature is, for example, 120° C. or less, preferably 100° C. or less. Furthermore, the reaction time is, for example, 0.5 hours or more, preferably 1 hour or more. Furthermore, the reaction time is, for example, 15 hours or less.

In this manner, a reaction mixture including the isocyanate group-terminated prepolymer is produced. The reaction mixture has an isocyanate group concentration of for example, 10.0% by mass or more, preferably 20.0% by mass or more. Furthermore, the reaction mixture has an isocyanate group concentration of, for example, 50.0% by mass or less, preferably 40.0% by mass or less.

Next, in this method, the reaction mixture is purified (the second step). In this manner, an isocyanate group-terminated prepolymer is produced as a purified solution.

Examples of the purification method include distillation and extraction. As the purification method, distillation is preferably used. In other words, in the second step, the reaction mixture is purified preferably by distillation to produce a purified solution.

The distillation method is not especially limited, and examples thereof include a batch distillation method and a continuous distillation method. A continuous distillation method is preferably used. Examples of the continuous distillation method include a thin film distillation method (a Smith-type thin film distillation method). As the distillation method, a thin film distillation method (a Smith-type thin film distillation method) is preferably used.

In the thin film distillation method, the distillation temperature is, for example, 120° C. or more, preferably 150° C. or more. Furthermore, the distillation temperature is, for example, 250° C. or less, preferably 200° C. or less.

Furthermore, the distillation pressure (absolute pressure) is, for example, 1 Pa or more, preferably 10 Pa or more, more preferably 50 Pa or more. Furthermore, the distillation pressure (absolute pressure) is, for example, 300 Pa or less, preferably 200 Pa or less, more preferably 100 Pa or less.

Furthermore, the feed amount of the reaction mixture is, for example, 0.1 g/min or more, preferably 1.0 g/min or more, more preferably 2.0 g/min or more. Furthermore, the feed amount of the reaction mixture is, for example, 100 g/min or less, preferably 50 g/min or less, more preferably 10 g/min or less.

In this manner, an unreacted polyisocyanate component is removed from the reaction mixture of the first step. As a result, as a purified solution, an isocyanate group-terminated prepolymer is produced. The weight-average molecular weight, number average molecular weight, and dispersion index of the isocyanate group-terminated prepolymer are in the above-described ranges.

The isocyanate group-terminated prepolymer may contain an unreacted polyisocyanate component as unavoidable impurities. To the total amount of the isocyanate group-terminated prepolymer and the unreacated polyisocyanate component, the ratio of the unreacted polyisocyanate component is, for example, 0.1% by mass or less. In other words, the purity of the isocyanate group-terminated prepolymer is, for example, 99.9% by mass or more.

Next, in this method, the above-described isocyanate monomer is added to (the purified solution of) the above-described isocyanate group-terminated prepolymer to prepare a prepolymer composition (the third step).

In the third step, the content ratio of the isocyanate group-terminated prepolymer to the isocyanate monomer is adjusted so that the isocyanate group concentration of the prepolymer composition is in the above-described range.

More specifically, with respect to the total amount of the isocyanate group-terminated prepolymer and the isocyanate monomer, the isocyanate group-terminated prepolymer is, for example, 50% by mass or more, preferably 60% by mass or more, more preferably 70% by mass or more, even more preferably 80% by mass or more. Furthermore, the isocyanate group-terminated prepolymer is, for example, 98% by mass or less, preferably 95% by mass or less, more preferably 90% by mass or less. Furthermore, the isocyanate monomer is, for example, 2% by mass or more, preferably 5% by mass or more, more preferably 10% by mass or more. Furthermore, the isocyanate monomer is, for example, 50% by mass or less, preferably 40% by mass or less, more preferably 30% by mass or less, even more preferably 20% by mass or less.

In this manner, a prepolymer composition including the isocyanate group-terminated prepolymer and the isocyanate monomer is prepared. The isocyanate group concentration of the prepolymer composition is in the above-described range.

Thereafter, in this method, the above-described prepolymer composition is reacted with the chain extending component (the fourth step).

More specifically, as the content ratio of the prepolymer composition to the chain extending component, the equivalent ratio R (NCO/OH) of the isocyanate group in the prepolymer composition to the hydroxyl group in the chain extending component (the chain extender) is, for example, 0.90 or more, preferably, 1.00 or more. Furthermore, the equivalent ratio R (NCO/OH) of the isocyanate group in the prepolymer composition to the hydroxyl group in the chain extending component (the chain extender) is, for example, 1.33 or less, preferably 1.25 or less.

In the fourth step, examples of the reaction method include the above-described bulk polymerization and the above-described solution polymerization. In bulk polymerization, the reaction temperature is, for example, 50° C. or more, preferably 100° C. or more. Furthermore, the reaction temperature is, for example, 250° C. or less, preferably 200° C. or less, more preferably 180° C. or less, even more preferably 150° C. or less. Furthermore, the reaction time is, for example, 0.5 hours or more, preferably 1 hour or more. Furthermore, the reaction time is, for example, 24 hours or less, preferably 20 hours or less, more preferably 18 hours or less.

In solution polymerization, the reaction temperature is, for example, 50° C. or more. Furthermore, the reaction temperature is, for example, 120° C. or less, preferably 150° C. or less. Furthermore, the reaction time is, for example, 0.5 hour or more, preferably 1 hour or more. Furthermore, the reaction time is, for example, 24 hours or less. Furthermore, as necessary, for example, a known urethane-forming catalyst can be added thereto. The ratio of the added urethane-forming catalyst to the total amount of the prepolymer composition, the chain extending component, and the urethane-forming catalyst is, for example, 5 ppm or more, preferably 10 ppm or more, more preferably 30 ppm or more, even more preferably 50 ppm or more. Furthermore, the ratio of the added urethane-forming catalyst to the total amount of the prepolymer composition, the chain extending component, and the urethane-forming catalyst is, for example, 1000 ppm or less, preferably 500 ppm or less, more preferably 300 ppm or less, even more preferably 200 ppm or less.

In this manner, a polyurethane resin including a reaction product of the prepolymer composition and the chain extending component is produced. Preferably, as necessary, the mixture of the prepolymer composition and the chain extending component is defoamed and cured in a mold preliminarily heated, and demolded. In this manner, a polyurethane resin molded into a desired shape is produced.

In the above-described method, a reaction mixture including the isocyanate group-terminated prepolymer is prepared (the first step), next, the isocyanate group-terminated prepolymer is purified by distillation (the second step), and thereafter the isocyanate group-terminated prepolymer is mixed with the isocyanate monomer (the third step). However, as necessary, the second step and/or the third step can be omitted.

That is to say, after the reaction mixture including the isocyanate group-terminated prepolymer is prepared (the first step), the isocyanate group-terminated prepolymer and the isocyanate monomer are mixed together (the third step) without the purification as described above. In this manner, a prepolymer composition can be produced.

Alternatively, for example, after the reaction mixture including the isocyanate group-terminated prepolymer is prepared (the first step), purification is carried out as described above (the second step). A prepolymer composition can be produced as a purified solution by the purification.

Also, by subjecting the prepolymer composition as described above to the above-described fourth step, a polyurethane resin can be produced.

As necessary, the polyurethane resin may be subjected to a heat treatment. The heat treatment temperature is, for example, 50° C. or more, preferably 80° C. or more. Furthermore, the heat treatment temperature is, for example, 200° C. or less, preferably 150° C. or less. Furthermore, the heat treatment time is, for example, 30 minutes or more, preferably 1 hour or more. Furthermore, the heat treatment time is, for example, 30 hours or less, preferably 20 hours or less.

Furthermore, the polyurethane resin may be aged. The aging temperature is, for example, 10° C. or more, preferably 20° C. or more. Furthermore, the aging temperature is, for example, 50° C. or less, preferably 40° C. or less. Furthermore, the aging time is, for example, 1 hour or more, preferably 10 hours or more. Furthermore, the aging time is, for example, 50 days or less, preferably 30 days or less.

As necessary, the polyurethane resin can include a known additive. That is to say, the polyurethane resin may be a polyurethane resin composition. Examples of the additive include a urethane-forming catalyst, a catalytic activity adjusting agent, an antioxidant, a heat-resistant stabilizer, a light-resistant stabilizer, an ultraviolet absorber, an antiblocking agent, a mold release agent, a pigment, a dye, a lubricant, a filler, a hydrolysis inhibitor, an antirust agent, and a bluing agent. The added amount of the additive and the timing of the addition are appropriately set depending on the purpose and use.

Then, the above-described polyurethane resin has both excellent mechanical properties (high hardness) and a low exothermic property.

That is to say, in the above-described polyurethane resin, the prepolymer composition has an isocyanate group concentration less than a predetermined value. Furthermore, in the above-described polyurethane resin, the isocyanate group-terminated prepolymer included in the prepolymer composition has a dispersion index (Mw/Mn) less than a predetermined value.

Therefore, according to the above-described prepolymer composition, the polyurethane resin have both excellent mechanical properties (high hardness) and a low exothermic property can be produced.

Furthermore, the above-described polyurethane resin has both excellent mechanical properties (a high hardness) and a low exothermic property.

As a result, the above-described polyurethane resin and prepolymer composition are preferably used in various industrial fields requiring mechanical properties (high hardness) and a low exothermic property. Examples of the industrial fields include elastic molded articles, paints, coating agents, and adhesives.

Preferably, the above-described polyurethane resin and prepolymer composition are used in the field of elastic molded articles.

Examples of the elastic molded articles include a polyurethane elastomer. Examples of the polyurethane elastomer include TPU (thermoplastic polyurethane resin) and TSU (thermosetting polyurethane resin). The elastic molded article is preferably TSU (thermosetting polyurethane resin).

The elastic molded article is produced by molding the polyurethane resin by a known molding method. Examples of the molding method include cast molding, thermal compression molding, injection molding, extrusion molding, and spinning molding. Furthermore, examples of the shape after the molding include a board shape, a fiber shape, a strand shape, a film shape, a sheet shape, a pipe shape, a bolt shape, a hollow shape, a box shape, and a button shape.

The elastic molded article is preferably produced by cast molding. Therefore, the elastic molded article is preferably a cast molded polyurethane elastomer. The cast molded polyurethane elastomer is a molded article produced by cast molding (cast molded product), and a product solely having a predetermined shape depending on the purpose and use, and distinguished from a coating agent applied to an object to be coated.

The elastic molded article described above includes the above-described polyurethane resin, and thus has excellent mechanical strength and can suppress the catch of air bubbles. Therefore, the elastic molded article is preferably used for various uses. Examples of the uses of the elastic molded article include, for example, transparent rigid plastics, waterproof materials, potting agents, inks, binders, films, sheets, bands, belts, shoe press belts, tubes, blades, loudspeakers, sensors, outsoles, threads, fibers, non-woven fabrics, cosmetic products, items of shoes, heat insulators, seal materials, tape materials, sealing materials, photovoltaic components, robot components, android components, wearable components, items of clothing, hygiene products, cosmetic items, furniture products, components for food-packaging, sports items, leisure items, medical products, nursing care products, house components, audio components, lighting components, vibration-proof components, acoustic insulation components, daily use items, sundry items, cushion, bedclothes, stress absorbers, stress relaxation materials, car interior materials, car exterior materials, components for railway, aircraft components, optical elements, components for office automation equipment, sundry item-surface protection materials, sealing materials for semiconductors, self-repairing materials, health appliances, lenses for eyeglasses, toys, packings, cable sheaths, wire harnesses, electrical communication cables, wiring for vehicles, computer wiring, industry products, shock absorbers, semiconductor products, polishing pads, and bridge bearings.

### EXAMPLES

Next, the present invention is described based on Examples and Comparative Examples. The present invention is, however, not limited to them. The “parts” and “%” are based on mass unless otherwise specified. The specific numeral values used in the description below, such as mixing ratios (content ratios), physical property values, and parameters, can be replaced with the corresponding mixing ratios (content ratios), physical property values, and parameters in the above-described “DESCRIPTION OF THE EMBODIMENTS”, including the upper limit values (numeral values defined with “or less”, and “less than”) or the lower limit values (numeral values defined with “or more”, and “more than”).

### 1. Raw Materials

### Polyisocyanate Component, Isocyanate Monomer

### Production Example 1 (1,4-H₆XDI, Trans-Isomer 93 Mol %)

Using 1,4-bis(aminomethyl)cyclohexane (manufactured by Mitsubishi Gas Chemical Company, Inc.) having a trans/cis ratio of 93/7 measured by ¹³C-NMR measurement as a raw material, a cold/thermal two-step phosgenation method was carried out under increased pressure.

That is to say, 2500 parts by mass of o-dichlorobenzene was charged into a jacketed pressure reaction vessel equipped with an electromagnetic induction stirrer, an automatic pressure control valve, a thermometer, a nitrogen inlet line, a phosgene inlet line, a condenser, and a material feed pump. Next, 1425 parts by mass of phosgene was added from the phosgene inlet line, and the stirring thereof was started. Cold water was allowed to pass the jacket of the reaction vessel, and the internal temperature was kept about 10° C. Then, a solution obtained by dissolving 400 parts by mass of 1,4-bis(aminomethyl)cyclohexane in 2500 parts by mass of the o-dichlorobenzene was fed with the feed pump for 60 minutes, and the cold phosgenation was started at 30° C. or less under a normal pressure. After the completion of the feeding, the inside of the flask became pale brownish white slurry.

Next, while the temperature of the solution in the reaction vessel was increased to 140° C. for 60 minutes, a pressure was applied thereto until 0.25 MPa. Thermal phosgenation was further carried out at a pressure of 0.25 MPa at a reaction temperature of 140° C. for two hours. Furthermore, in the middle of the thermal phosgenation, 480 parts by mass of the phosgene was added. In the process of the thermal phosgenation, the internal liquid in the flask became a pale brownish clear solution. After the completion of the thermal phosgenation, nitrogen gas was allowed to pass at 100 L/hour at 100 to 140° C. to carry out degassing. Next, the ortho-dichlorobenzene solvent was distilled off under reduced pressure, and thereafter, using a rectifying column equipped with a distillation tube filled with four elements of packing (manufactured by Sumitomo Heavy Industries Ltd., trade name: Sumitomo/Sulzer Labo Packing EX), a distillation column equipped with a reflux ratio control timer (manufactured by Sibata Scientific Technology Ltd., trade name: distillation column K type), and a condenser, the remainder was further rectified with refluxing in a glass flask under the conditions of 138 to 143° C. and 0.7 to 1 KPa, to produce 382 parts by mass of 1,4-H₆XDI. The purity of the produced 1,4-H₆XDI measured by gas chromatography was 99.9%, the hue measured by APHA measurement was 5, and the trans/cis ratio measured by ¹³C-NMR was 93/7. The hydrolyzable chlorine (HC) was 19 ppm.

### Production Example 2 (1,4-H₆XDI, Trans-Isomer 41 Mol %)

Using 1,4-bis(aminomethyl)cyclohexane (manufactured by Tokyo Chemical Industry Co., Ltd.) having a trans/cis ratio of 41/59 measured by ¹³C-NMR measurement as a raw material, 388 parts by mass of 1,4-bis(isocyanatomethyl)cyclohexane having a trans/cis ratio of 41/59 was produced in the same manner as Production Example 1. The purity of the produced 1,4-H₆XDI measured by gas chromatography was 99.9%, the hue measured by APHA measurement was 5, and the trans/cis ratio measured by ¹³C-NMR measurement was 41/59. The HC was 22 ppm.

### Production Example 3 (1,4-H₆XDI, Trans-Isomer 86 Mol %)

865 parts by mass of 1,4-H₆XDI (trans-isomer 93 mol %) of Production Example 1 and 135 parts by mass of 1,4-H₆XDI (trans-isomer 41 mol %) of Production Example 2 were charged into a four-neck flask equipped with a stirrer, a thermometer, a reflux tube, and a nitrogen inlet tube and stirred under a nitrogen atmosphere at room temperature for one hour. The purity of the produced 1,4-H₆XDI measured by gas chromatography was 99.9%, the hue measured by APHA measurement was 5, and the trans/cis ratio measured by ¹³C-NMR measurement was 86/14. The HC was 19 ppm.

### <Polyol Component>

PTMEG1000: polytetramethylene ether glycol, a number average molecular weight (Mn) 1000
PTMEG650: polytetramethylene ether glycol, a number average molecular weight (Mn) 650
PBA1000: condensed polyester diol (polybutylene adipate), a number average molecular weight (Mn) 1000
PCL1000: polycaproctone diol, a number average molecular weight (Mn) 1000
PC1000: polycarbonate diol, a number average molecular weight (Mn) 1000

### <Chain Extender>

1,4-BD: 1, 4-butane diol

### <Urethane-Forming Catalyst>

DBTDL: dibutyltin dilaurate, organic tin catalyst

### 2. Prepolymer Composition and Polyurethane Resin

### Examples 1 to 17 and Comparative Examples 1 to 3

### (1) First Step

According to the formulations and conditions shown in Tables 1 to 3, the polyisocyanate component and the polyol component were reacted under a nitrogen atmosphere. The polyisocyanate component and the polyol component are blended so that an unreacted polyisocyanate component (isocyanate monomer) remains. In Tables 1 to 3, the equivalent ratio R of the first step indicates the equivalent ratio R (NCO/OH) of the isocyanate group in the polyisocyanate component to the hydroxyl group in the polyol component.

### (2) Second Step

Next, according to the formulations and conditions shown in Tables 1 to 3, the above-described reaction mixture was subjected to thin-film distillation until the content of the isocyanate monomer reached 0.1% by mass, thereby producing a purified solution of the isocyanate group-terminated prepolymer. Furthermore, using the purified solution, the weight-average molecular weight (Mw) and number average molecular weight (Mn) of the isocyanate group-terminated prepolymer were measured under the conditions described below. Furthermore, the dispersion index (Mw/Mn) of the isocyanate group-terminated prepolymer was calculated.

### (3) Third Step

According to the formulations shown in Tables 1 to 3, an isocyanate monomer and a urethane-forming catalyst as an additive were added to the purified solution of the isocyanate group-terminated prepolymer. In this manner, a prepolymer composition is produced.

In Tables 1 to 3, the added amount of the monomer indicates the ratio of the isocyanate monomer to the total amount of the purified solution of the isocyanate group-terminated prepolymer and the isocyanate monomer. In Comparative Example 1 and Examples 9, 11, 12, 14, and 16, an isocyanate monomer was not added.

### (4) Fourth Step

According to the formulations shown in Tables 1 to 3, a prepolymer composition and a chain extending component were prepared, and heated to 60° C. In the presence of the urethane-forming catalyst shown in Tables 1 to 3, the prepolymer composition and the chain extending component were mixed together for 60 seconds and defoamed at reduced pressure at room temperature for 60 seconds. Thereafter, the mixture was poured into a mold at 110° C. and reacted at 110° C. for 16 hours. Thereafter, aging was carried out at 23° C. for 3 weeks. In this manner, a polyurethane resin (a cast molded polyurethane elastomer) was produced. The amount (ppm) of the urethane-forming catalyst in Tables indicates the ratio of the urethane-forming catalyst to the total amount of the prepolymer composition, the chain extending component, and the urethane-forming catalyst.

### 3. Measurement of Physical Properties

(1) Dispersion index (Mw/Mn)

Using Gel Permeation Chromatography equipped with a differential refractometer, the prepolymer composition was measured by GPC. Polystyrene was used as a standard sample. Based on the results of the GPC measurement, the weight-average molecular weight (in terms of polystyrene, Mw), number average molecular weight (in terms of polystyrene, Mn), and dispersion index (Mw/Mn) of the isocyanate group-terminated prepolymer were calculated. The details of the method of GPC measurement are described below.

That is to say, 0.05 g of (the purified solution of) the isocyanate group-terminated prepolymer were dissolved into 1 to 2 mL of methanol in a glass bottle, and left to stand at room temperature for three days. In this manner, the methyl urethane-forming of the sample was carried out. When the sample was not dissolved into methanol, dichloromethane (a dissolving aid) was added thereto to dissolve the sample.

Thereafter, while N₂ was sprayed on the sample, the sample was heated to 50° C. to volatilize the solvent including methanol. In this manner, a sample in a solid state was produced. The sample was dissolved into N,N′-dimethyl formamide (DMF) to produce 0.625% by mass of a solution. The produced solution was measured by GPC under the conditions below.
(1) Analysis device: HLC-8220GPC (TOSOH CORPORATION)
(2) Pump: attached to the device
(3) Detector: attached to the device: RI detector
(4) Eluent: DMF (LiBr 0.86 g/L)
(5) Separation column: three pieces of Super AWM-H
   Maker: TOSOH CORPORATION
   Product Number: 19320
(6) Measurement temperature: 40° C.
(7) Flow rate: Sample pump 0.6 mL/min, Reference pump 0.6 mL/min
(8) Sample injection amount: 20 L
(9) Analyzer: Analyzing software GPC-8020mII (TOSOH CORPORATION) System Correction
(10) Standard sample name: Polystyrene

### (2) Isocyanate Group Concentration

The isocyanate group concentration was measured in accordance with the n-dibutylamine method of JIS K 1556 (2006).

### 4. Evaluations

### (1) Hardness

The shore D hardness of the polyurethane resin was measured in accordance with JIS K 7312 (1996).

### (2) Low Exothermic Property

As the index of a low exothermic property, the loss tangent (tan δ) of the polyurethane resin was calculated. More specifically, the dynamic viscoelasticity spectrum of the polyurethane resin was measured using Dynamic Viscoelastic Analyzer (manufactured by IT Sokuryo Seigyo Co., Ltd., Model: DVA-220) under the conditions of a measurement start temperature of −100° C., a rate of temperature increase of 5° C./min, a tensile mode, a length between scale lines of 20 mm, a static/dynamic stress ratio of 1.8, and a measurement frequency of 10 Hz. Thereafter, the loss tangent (tan δ) at 40° C. was calculated.

### [Table 1]

| No. | | Comp. Ex. 1 | Comp. Ex. 2 | Example 1 | Example 2 |
|---|---|---|---|---|---|
| First step | Polyisocyanate component | 1,4-H6XDI | 1,4-H6XDI | 1,4-H6XDI | 1,4-H6XDI |
| | Cis isomer/trans isomer | 14/86 | 14/86 | 14/86 | 14/86 |
| | (mol ratio) | | | | |
| | Polyol component | PTMEG1000 | PTMEG1000 | PTMEG1000 | PTMEG1000 |
| | Equivalent ratio R(NCO/OH) | 2.9 | 5.0 | 7.0 | 9.0 |
| | Reaction temperature (° C.) | 80 | 80 | 80 | 80 |
| | Reaction time (hour) | 3 | 3 | 3 | 3 |
| Second step | Presence or absence of thin film | Absence | Presence | Presence | Presence |
| | distillation | | | | |
| | Distillation temperature (° C.) | — | 150 | 150 | 150 |
| | Distillation pressure (Pa) | — | 50 | 50 | 50 |
| Isocyanate group- | Weight-average molecular weight | 5230 | 3723 | 3144 | 3300 |
| terminated | (Mw) | | | | |
| prepolymer | Number average molecular | 2761 | 1903 | 1817 | 2000 |
| | weight (Mn) | | | | |
| | Dispersion index (Mw/Mn) | 1.98 | 1.90 | 1.73 | 1.65 |
| Third step | Isocyanate monomer | — | 1,4-H6XDI | 1,4-H6XDI | 1,4-H6XDI |
| | Cis isomer/trans isomer | 14/86 | 14/86 | 14/86 | 14/86 |
| | (mol ratio) | | | | |
| | Added amount of monomer | — | 13.0 | 12.5 | 12.0 |
| | (% by mass) | | | | |
| Prepolymer | Isocyanate group concentration | 10.0 | 10.0 | 10.0 | 10.0 |
| composition | (% by mass) | | | | |
| Fourth step | Chain extender | 1,4-BD | 1,4-BD | 1,4-BD | 1,4-BD |
| | Equivalent ratio R(NCO/OH) | 1.05 | 1.05 | 1.05 | 1.05 |
| | Urethane-forming catalyst | DBTDL | DBTDL | DBTDL | DBTDL |
| | Amount of urethane-forming | 200 | 200 | 200 | 200 |
| | catalyst (ppm) | | | | |
| | Curing temperature (° C.) | 110 | 110 | 110 | 110 |
| | Curing time (hour) | 16 | 16 | 16 | 16 |
| Evaluations | Low exothermic property | 0.050 | 0.050 | 0.035 | 0.030 |
| | (tanδ [40° C.]) | | | | |
| | Hardness shore D | 45 | 46 | 47 | 48 |
| No. | | Example 3 | Example 4 | Example 5 | Example 6 |
| First step | Polyisocyanate component | 1,4-H6XDI | 1,4-H6XDI | 1,4-H6XDI | 1,4-H6XDI |
| | Cis isomer/trans isomer | 14/86 | 14/86 | 14/86 | 14/86 |
| | (mol ratio) | | | | |
| | Polyol component | PTMEG650 | PBA1000 | PCL1000 | PC1000 |
| | Equivalent ratio R(NCO/OH) | 9.0 | 9.0 | 9.0 | 9.0 |
| | Reaction temperature (° C.) | 80 | 80 | 80 | 80 |
| | Reaction time (hour) | 3 | 3 | 3 | 3 |
| Second step | Presence or absence of thin film | Presence | Presence | Presence | Presence |
| | distillation | | | | |
| | Distillation temperature (° C.) | 150 | 150 | 150 | 150 |
| | Distillation pressure (Pa) | 50 | 50 | 50 | 50 |
| Isocyanate group- | Weight-average molecular weight | 2100 | 3650 | 3580 | 3600 |
| terminated | (Mw) | | | | |
| prepolymer | Number average molecular | 1500 | 2100 | 2100 | 2100 |
| | weight (Mn) | | | | |
| | Dispersion index (Mw/Mn) | 1.40 | 1.74 | 1.70 | 1.71 |
| Third step | Isocyanate monomer | 1,4-H6XDI | 1,4-H6XDI | 1,4-H6XDI | 1,4-H6XDI |
| | Cis isomer/trans isomer | 14/86 | 14/86 | 14/86 | 14/86 |
| | (mol ratio) | | | | |
| | Added amount of monomer | 7.0 | 12.0 | 12.0 | 12.0 |
| | (% by mass) | | | | |
| Prepolymer | Isocyanate group concentration | 10.0 | 10.0 | 10.0 | 10.0 |
| composition | (% by mass) | | | | |
| Fourth step | Chain extender | 1,4-BD | 1,4-BD | 1,4-BD | 1,4-BD |
| | Equivalent ratio R(NCO/OH) | 1.05 | 1.05 | 1.05 | 1.05 |
| | Urethane-forming catalyst | DBTDL | DBTDL | DBTDL | DBTDL |
| | Amount of urethane-forming | 200 | 200 | 200 | 200 |
| | catalyst (ppm) | | | | |
| | Curing temperature (° C.) | 110 | 110 | 110 | 110 |
| | Curing time (hour) | 16 | 16 | 16 | 16 |
| Evaluations | Low exothermic property | 0.040 | 0.030 | 0.030 | 0.040 |
| | (tanδ [40° C.]) | | | | |
| | Hardness shore D | 51 | 47 | 47 | 50 |

TABLE 2

| No. | | Example 7 | Example 8 | Example 9 | Example 10 | Example 11 | Comp. Ex. 3 |
|---|---|---|---|---|---|---|---|
| First step | Polyisocyanate component | 1,4-H6XDI | 1,4-H6XDI | 1,4-H6XDI | 1,4-H6XDI | 1,4-H6XDI | 1,4-H6XDI |
| | Cis isomer/trans isomer | 14/86 | 14/86 | 14/86 | 7/93 | 7/93 | 14/86 |
| | (mol ratio) | | | | | | |
| | Polyol component | PTMEG1000 | PTMEG1000 | PTMEG1000 | PTMEG1000 | PTMEG1000 | PTMEG1000 |
| | Equivalent ratio R(NCO/OH) | 9.0 | 9.0 | 9.0 | 9.0 | 9.0 | 9.0 |
| | Reaction temperature (° C.) | 80 | 80 | 80 | 80 | 80 | 80 |
| | Reaction time (hour) | 3 | 3 | 3 | 3 | 3 | 3 |
| Second step | Presence or absence of thin film | Presence | Presence | Presence | Presence | Presence | Presence |
| | distillation | | | | | | |
| | Distillation temperature (° C.) | 150 | 150 | 150 | 150 | 150 | 150 |
| | Distillation pressure (Pa) | 50 | 50 | 50 | 50 | 50 | 50 |
| Isocyanate group- | Weight-average molecular weight | 3300 | 3300 | 3300 | 3300 | 3300 | 3300 |
| terminated | (Mw) | | | | | | |
| prepolymer | Number average molecular | 2000 | 2000 | 2000 | 2000 | 2000 | 2000 |
| | weight (Mn) | | | | | | |
| | Dispersion index (Mw/Mn) | 1.65 | 1.65 | 1.65 | 1.65 | 1.65 | 1.65 |
| Third step | Isocyanate monomer | 1,4-H6XDI | 1,4-H6XDI | — | 1,4-H6XDI | — | 1,4-H6XDI |
| | Cis isomer/trans isomer | 14/86 | 14/86 | 14/86 | 7/93 | 7/93 | 14/86 |
| | (mol ratio) | | | | | | |
| | Added amount of monomer | 7.0 | 17.0 | — | 17.0 | — | 27.0 |
| | (% by mass) | | | | | | |
| Prepolymer | Isocyanate group concentration | 8.0 | 12.0 | 5.7 | 12.0 | 5.7 | 15.0 |
| composition | (% by mass) | | | | | | |
| Fourth step | Chain extender | 1,4-BD | 1,4-BD | 1,4-BD | 1,4-BD | 1,4-BD | 1,4-BD |
| | Equivalent ratio R(NCO/OH) | 1.05 | 1.05 | 1.05 | 1.05 | 1.05 | 1.05 |
| | Urethane-forming catalyst | DBTDL | DBTDL | DBTDL | DBTDL | DBTDL | DBTDL |
| | Amount of urethane-forming | 200 | 200 | 200 | 200 | 200 | 200 |
| | catalyst (ppm) | | | | | | |
| | Curing temperature (° C.) | 110 | 110 | 110 | 110 | 110 | 110 |
| | Curing time (hour) | 16 | 16 | 16 | 16 | 16 | 16 |
| Evaluations | Low exothermic property | 0.025 | 0.030 | 0.020 | 0.025 | 0.015 | 0.060 |
| | (tanδ [40° C.]) | | | | | | |
| | Hardness shore D | 46 | 50 | 45 | 51 | 46 | 52 |

### [Table 3]

| No. | | Example 12 | Example 13 | Example 14 | Example 15 | Example 16 | Example 17 |
|---|---|---|---|---|---|---|---|
| First step | Polyisocyanate component | 1,4-H6XDI | 1,4-H6XDI | 1,4-H6XDI | 1,4-H6XDI | 1,4-H6XDI | 1,4-H6XDI |
| | Cis isomer/trans isomer | 14/86 | 14/86 | 14/86 | 14/86 | 14/86 | 14/86 |
| | (mol ratio) | | | | | | |
| | Polyol component | PTMEG650 | PTMEG650 | PCL1000 | PCL1000 | PC1000 | PC1000 |
| | Equivalent ratio R(NCO/OH) | 9.0 | 9.0 | 9.0 | 9.0 | 9.0 | 9.0 |
| | Reaction temperature (° C.) | 80 | 80 | 80 | 80 | 80 | 80 |
| | Reaction time (hour) | 3 | 3 | 3 | 3 | 3 | 3 |
| Second step | Presence or absence of thin film | Presence | Presence | Presence | Presence | Presence | Presence |
| | distillation | | | | | | |
| | Distillation temperature (° C.) | 150 | 150 | 150 | 150 | 150 | 150 |
| | Distillation pressure (Pa) | 50 | 50 | 50 | 50 | 50 | 50 |
| Isocyanate group- | Weight-average molecular weight | 2100 | 2100 | 3580 | 3580 | 3600 | 3600 |
| terminated | (Mw) | | | | | | |
| prepolymer | Number average molecular | 1500 | 1500 | 2100 | 2100 | 2100 | 2100 |
| | weight (Mn) | | | | | | |
| | Dispersion index (Mw/Mn) | 1.40 | 1.40 | 1.70 | 1.70 | 1.71 | 1.71 |
| Third step | Isocyanate monomer | 1,4-H6XDI | 1,4-H6XDI | 1,4-H6XDI | 1,4-H6XDI | 1,4-H6XDI | 1,4-H6XDI |
| | Cis isomer/trans isomer | 14/86 | 14/86 | 14/86 | 14/86 | 14/86 | 14/86 |
| | (mol ratio) | | | | | | |
| | Added amount of monomer | — | 18.0 | — | 17.0 | — | 17.0 |
| | (% by mass) | | | | | | |
| Prepolymer | Isocyanate group concentration | 7.7 | 14.0 | 5.7 | 12.0 | 5.7 | 12.0 |
| composition | (% by mass) | | | | | | |
| Fourth step | Chain extender | 1,4-BD | 1,4-BD | 1,4-BD | 1,4-BD | 1,4-BD | 1,4-BD |
| | Equivalent ratio R(NCO/OH) | 1.05 | 1.05 | 1.05 | 1.05 | 1.05 | 1.05 |
| | Urethane-forming catalyst | DBTDL | DBTDL | DBTDL | DBTDL | DBTDL | DBTDL |
| | Amount of urethane-forming | 100 | 200 | 50 | 200 | 50 | 200 |
| | catalyst (ppm) | | | | | | |
| | Curing temperature (° C.) | 110 | 110 | 110 | 110 | 110 | 110 |
| | Curing time (hour) | 16 | 16 | 16 | 16 | 16 | 16 |
| Evaluations | Low exothermic property | 0.030 | 0.050 | 0.020 | 0.030 | 0.030 | 0.045 |
| | (tanδ [40° C.]) | | | | | | |
| | Hardness shore D | 51 | 56 | 45 | 50 | 48 | 53 |

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The prepolymer composition, polyurethane resin, elastic molded article, and method of producing the prepolymer composition of the present invention are preferably used, for example, for transparent rigid plastics, waterproof materials, potting agents, inks, binders, films, sheets, bands, belts, shoe press belts, tubes, blades, loudspeakers, sensors, outsoles, threads, fibers, non-woven fabrics, cosmetic products, items of shoes, heat insulators, seal materials, tape materials, sealing materials, photovoltaic components, robot components, android components, wearable components, items of clothing, hygiene products, cosmetic items, furniture products, components for food-packaging, sports items, leisure items, medical products, nursing care products, house components, audio components, lighting components, vibration-proof components, acoustic insulation components, daily use items, sundry items, cushion, bedclothes, stress absorbers, stress relaxation materials, car interior materials, car exterior materials, components for railway, aircraft components, optical elements, components for office automation equipment, sundry item-surface protection materials, sealing materials for semiconductors, self-repairing materials, health appliances, lenses for eyeglasses, toys, packings, cable sheaths, wire harnesses, electrical communication cables, wiring for vehicles, computer wiring, industry products, shock absorbers, semiconductor products, and bridge bearings.

1. A prepolymer composition comprising: an isocyanate group-terminated prepolymer,
wherein the isocyanate group-terminated prepolymer contains a reaction product of a polyisocyanate component including 1,4-bis(isocyanatomethyl)cyclohexane and a polyol component,
wherein the isocyanate group-terminated prepolymer has a dispersion index (Mw/Mn) of 1.85 or less, and
wherein the prepolymer composition has an isocyanate group concentration of 14.0% by mass or less.

2. A polyurethane resin comprising: a reaction product of a prepolymer composition including an isocyanate group-terminated prepolymer and a chain extending component,
wherein the isocyanate group-terminated prepolymer contains a reaction product of a polyisocyanate component including 1,4-bis(isocyanatomethyl)cyclohexane and a polyol component,
wherein the isocyanate group-terminated prepolymer has a dispersion index (Mw/Mn) of 1.85 or less, and
wherein the prepolymer composition has an isocyanate group concentration of 14.0% by mass or less.

3. An elastic molded article comprising: the polyurethane resin according to claim 2.

4. A method of producing a prepolymer composition containing an isocyanate group-terminated prepolymer, the method comprising:
a first step of allowing a polyisocyanate component including 1,4-bis(isocyanatomethyl)cyclohexane to react with a polyol component to prepare a reaction mixture including an isocyanate group-terminated prepolymer; and
a second step of distilling the reaction mixture,
wherein in the first step, an equivalent ratio (NCO/OH) of an isocyanate group in the polyisocyanate component to a hydroxyl group in the polyol component is 7.0 or more,
wherein the isocyanate group-terminated prepolymer has a dispersion index (Mw/Mn) of 1.85 or less, and
wherein the prepolymer composition has an isocyanate group concentration of 14.0% by mass or less.

5. The method of producing a prepolymer composition according to claim 4, the method comprising:
a third step of adding an isocyanate monomer to a purified solution produced by the distillation after the second step,
wherein the isocyanate monomer contains 1,4-bis(isocyanatomethyl)cyclohexane.
